(19) United States
(12) Patent Application Publication
(10) Pub. No.: US 2015/0360624 A1
(43) Pub. Date: Dec. 17, 2015

(54) DECAL HOLDER

(71) Applicant: Solomon Reynolds, Chicago, IL (US)

(72) Inventor: Solomon Reynolds, Chicago, IL (US)

(21) Appl. No.: 14/303,928

(22) Filed: Jun. 13, 2014

(51) Int. Cl. B60R 13/10; G09F 21/04

(52) U.S. Cl. CPC B60R 13/105; G09F 21/04

(57) ABSTRACT

A decal holder for placement in a vehicle window that includes: a decal panel, where the decal panel receives a removable sticker on a first surface; a pull tab along a top side of the decal panel; a first sidewall, where a first slot is available within the first sidewall; a second sidewall, where a second slot is available within the second sidewall; a bottom support, extending inwardly from each respective sidewall, where the bottom support, the first slot and the second slot support and receive the decal panel. The decal holder may further include a clear cover extending between the first sidewall and second sidewall, where the clear cover. A back wall may be provided to support the decal panel and a back support is provided above the back wall to support the pull-tab.

### BACKGROUND OF THE INVENTION

1. Field of Invention

The present invention relates to a decal holder that provides a holder to display a window decal without adhering the decal to the window of a vehicle.

2. Description of Related Art

A necessity for a display of licensing and registration documents as related to motor vehicle operation is quite common. Many states and municipalities require visible display of proper registration and licensing associated with the operation of a motor vehicle. Many times these displays are required in the forms of plates that are placed on or near the vehicle's bumpers. Further other registration and vehicle information may be required which must be adhered directly to the windshield of the vehicle in the form of a sticker or decal. The adherence of the stickers also may relate to parking permits and other licenses or permits related to the particular vehicle. Many times these stickers adhere directly to the inside or outside surface of the windshield's vehicle. One drawback to the use of stickers or decals on the windshield is the necessity to remove the stickers when the particular license, registration or otherwise is expired or no longer associated with the vehicle. These stickers are usually difficult to remove and may leave residue on the windshield over a period of time. Further the sticker or decal may be placed on the inside surface to avoid any tampering or theft of the registration identification associated with the sticker. The stickers therefore serve the purpose of a highly visible registration display but some drawbacks may exist related to the removal and residue buildup that may be required to be removed from the inside of the windshield. As a consequence, it would be advantageous to have a device, which may provide for a visible display of the associated registration sticker but however avoids adhering the sticker in direct contact with the windshield.

### SUMMARY OF THE INVENTION

The present invention relates to a decal holder for placement in a vehicle window comprising: a decal panel, where the decal panel receives a removable sticker on a first surface; a pull tab along a top side of the decal panel; a first sidewall, where a first slot is available within the first sidewall; a second sidewall, where a second slot is available within the second sidewall; a bottom support, extending inwardly from each respective sidewall, where the bottom support, the first slot and the second slot support and receive the decal panel. The decal holder may further include a clear cover extending between the first sidewall and second sidewall, where the clear cover. A back wall may be provided to support the decal panel and a back support is provided above the back wall to support the pull-tab.

### BRIEF DESCRIPTION OF THE DRAWINGS

FIG. 1 depicts a top view of a decal holder in accordance with the present invention.

FIG. 2 depicts a front view of a decal holder in accordance with the present invention.

FIG. 3 depicts a side view of a decal holder in accordance with the present invention.

### DETAILED DESCRIPTION

The present invention relates to a decal holder capable of holding a display decal or sticker so that it will be visible in a window of a vehicle. The decal holder is attached directly to the window as opposed to a registration or identification sticker. The registration sticker is placed onto a decal panel that inserts into slots provided in sidewalls of the decal holder base. The base also includes a bottom support that extends from each sidewall. Slots within the sidewalls allow for the insertion of a decal panel that includes a pull-tab placed along the top edge of the decal panel. Placement of the pull-tab along the top edge of the decal panel enables for the insertion and removal of the decal panel from the slots. A clear cover may be provided in front of the decal panel extending between the respective sidewalls. During use this decal holder provides a convenient and effective means to place a visible vehicle registration or identification sticker onto the panel for display in the vehicle's window.

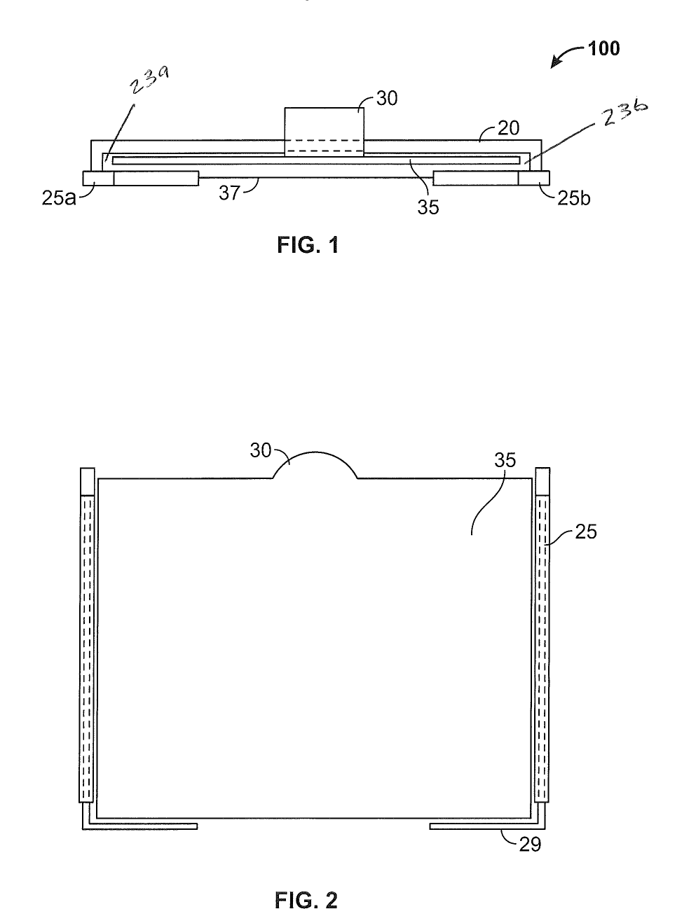

In reference to FIG. 1, a top view of a decal holder 100 in accordance with the present invention is depicted. The decal holder 100 includes sidewalls 25a, 25b on each respective side of the decal holder 100. A decal panel 35 is inserted between the sidewalls in slots that are created along each sidewall 25a, 25b of the decal holder 100. In this particular embodiment, a clear cover 37 is also shown in front of the decal panel 100 that covers the panel 100 during use. A pull-tab 30 is also shown that extends from a top edge of the decal panel 35. The decal panel 35 is held between the slots and supported with the back wall 20 of the decal holder 100.

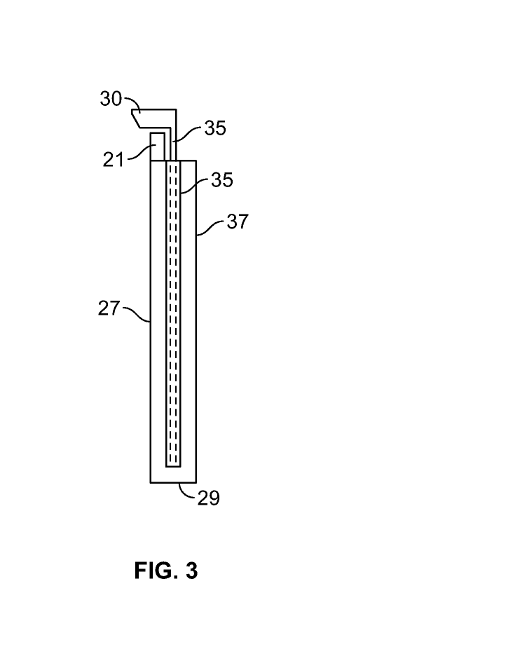

A front view of the decal holder 100 is shown in FIG. 2. In this front view a clear view of the decal panel 35 is provided that receives any decal or sticker directly onto surface thereof. Also shown is the pull-tab 30 along the top edge of the decal panel 35. The decal panel 35 is supported with bottom supports 29 that extend inwardly from each sidewall 25a, 25b. This configuration therefore creates a stable structure to support the decal panel 35 during use. A side view of the decal holder 100 is shown in FIG. 3. FIG. 3 provides a clear view of back support 21 that extends from the back wall 20. This back support 21 provides support for the pull-tab 30 and bottom supports 29 support a bottom edge of the decal panel 35. The decal holder according to the present invention therefore provides an effective means to display a visible registration sticker or decal in a motor vehicle window.

1. A decal holder for placement in a vehicle window comprising:
a. a decal panel, where the decal panel receives a removable sticker on a first surface;
b. a pull tab along a top side of the decal panel, where said pull tab extends at a 90 degree angle from the decal panel towards a back wall;
c. a first sidewall, where a first slot is available within the first sidewall;
d. a second sidewall, where a second slot is available within the second sidewall;
e. a bottom support, extending inwardly from each respective sidewall, where the bottom support, the first slot and the second slot support and receive the decal panel.

2. The decal holder according to claim 1 further including a clear cover extending between the first sidewall and second sidewall, where the clear cover provides a means to view the removable sticker.

3. The decal holder in accordance with claim 1, where a back wall is provided to support the decal panel and a back support is provided above the back wall to support the pull-tab.
